(19) United States
(12) Patent Application Publication
(10) Pub. No.: US 2003/0055682 A1
(43) Pub. Date: Mar. 20, 2003

(54) Remote medical system

(75) Inventor: Shunichi Tsuuki, Aichi (JP)

Correspondence Address: SUGHRUE MION, PLLC, 2100 Pennsylvania Avenue, N.W., Washington, DC, 20037, US

(73) Assignee: KABUSHIKI KAISHA COSMO JAPAN

(21) Appl. No.: 10/243,843

(22) Filed: Sep. 16, 2002

(30) Foreign Application Priority Data
Sep. 17, 2001 (JP) 2001-281384

(51) Int. Cl. G06F 17/60; G06F 15/16

(52) U.S. Cl. 705/2; 709/203

(57) ABSTRACT

Provided is a remote medical system capable of always and instantly coping with a counselee or examinee while reducing a load placed on a counseling doctor. The remote medical system includes a terminal device and a server, in which the terminal device measures a vital sign of a user; transmits the vital sign to a server; and receives medical information based on the vital sign from the server, and the server transmits; to a doctor in charge, the vital sign of the user received from the terminal device; and returns a medical examination result received from the doctor in charge to the terminal device.

### BACKGROUND OF THE INVENTION

1. Field of the Invention

The present invention relates to a remote medical system used to perform a medical action through an electrical communication line, and more particularly, to a novel improvement in which a user becomes capable of obtaining a medical examination result without difficulty using a terminal device.

2. Description of the Related Art

A conventionally used remote medical system of this type is shown in FIG. 3. For instance, it is possible to cite the structure of a Chorus Net system (“Chorus Net” is the trademark of NEC System Integration & Construction, Ltd., Parama-Tech, Co., Ltd., and TERADA ELECTRIC WORKS CO., LTD.). In FIG. 3, reference numeral 1 denotes each communication terminal device on a user side. With this communication terminal device 1, there is measured a vital sign, such as a blood pressure, and this vital sign is transmitted to a host computer 2 installed at a medical institution through a telephone line.

On the side of the host computer 2 at the medical institution, there is medically examined the vital sign transmitted from the communication terminal device 1 of the user and a medical examination result is sent to the user by mail or the like.

The conventional system is constructed in the manner described above, so that there exist the following problems. That is, after the transmission of the vital sign, the user is required to wait for a predetermined number of days before receiving the medical examination result.

Also, on the medical institution side, even if there is received the vital sign from the user, it is not always possible to issue the medical examination result without delay. In the case where a doctor in charge is outside the office, for instance, it is impossible to analyze the vital sign before the next consultation day comes. This means that there is a case where it is impossible to swiftly perform medical examination.

Further, the user is required to use a communication terminal device that is lent from the medical institution or the like, and therefore it has been desired the advent of a system that is easier to use.

### SUMMARY OF THE INVENTION

The present invention has been made to solve the problems described above, and an object of the invention is to provide a remote medical system capable of always and instantly coping with a counselee or examinee with a simple structure while reducing a load placed on a counseling doctor.

A remote medical system according to the present invention has a structure such that the system includes: a terminal device that measures a vital sign of a user, transmits the vital sign to a server, and receives medical information based on the vital sign from the server; and the server that transmits, to a doctor in charge, the vital sign of the user received from the terminal device and returns a medical examination result received from the doctor in charge to the terminal device. Also, the system has a structure such that the terminal device is an information terminal device installed at a store. Further, the system has a structure such that the server stores and holds a counseling time table of a plurality of counseling doctors, transmits the vital sign of the user to a counseling doctor, who is capable of being in charge in the case where the doctor in charge who previously handled the client is not currently on the job, in accordance with the counseling time table, and returns a medical examination result received from the counseling doctor to the user.

### BRIEF DESCRIPTION OF THE DRAWINGS

In the accompanying drawings:

FIG. 1 is a block diagram showing the outline of a remote medical system according to the present invention;

FIG. 2 is a flowchart showing the contents of control processing performed in the remote medical system according to the present invention; and

FIG. 3 is a block diagram showing the outline of a conventional remote medical system.

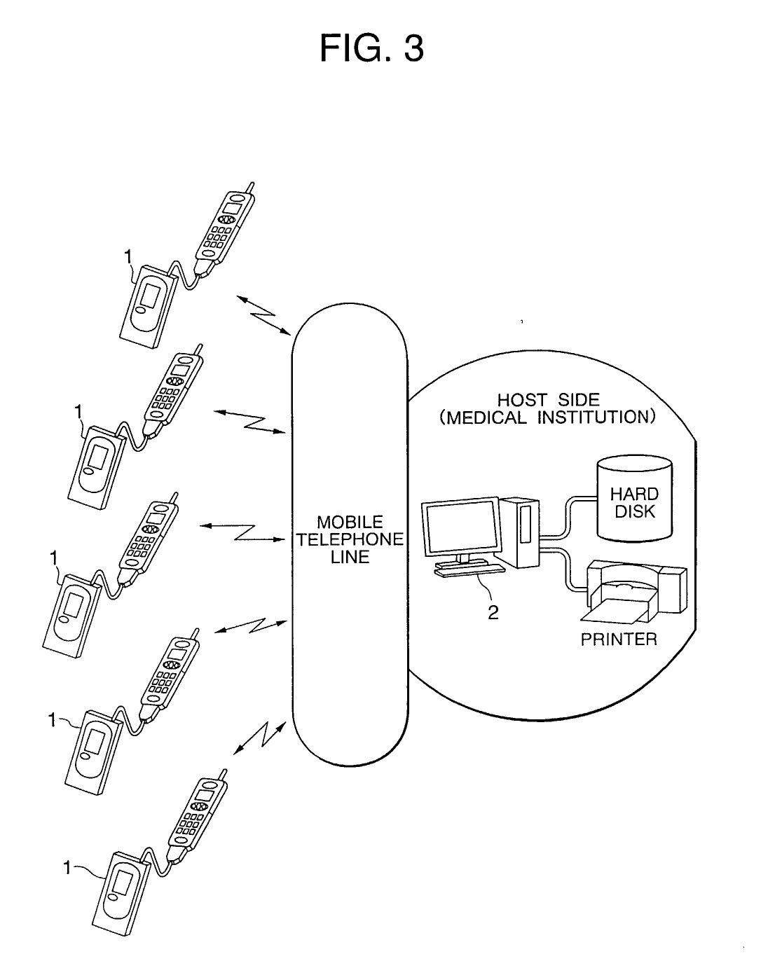

### DETAILED DESCRIPTION OF THE PREFERRED EMBODIMENTS

A preferred embodiment of a remote medical system according to the present invention will be described in detail below with reference to the drawings.

It should be noted here that portions, which are the same as those of the conventional apparatus or are equivalent to those of the conventional apparatus, are given the same reference numerals and the description thereof will be omitted.

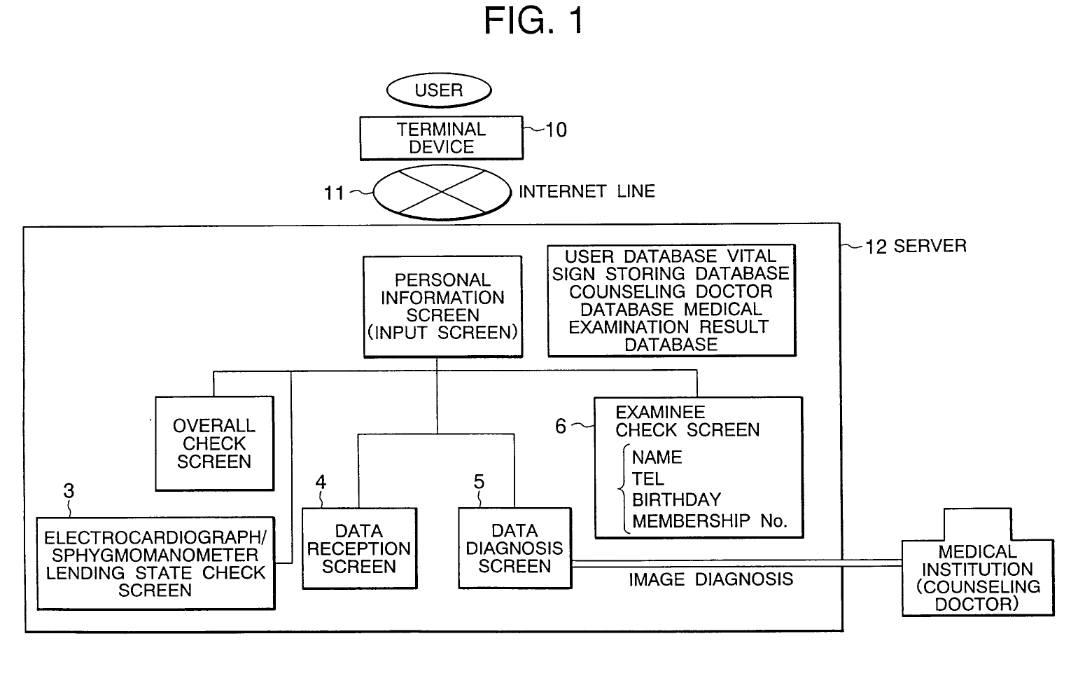

As shown in FIG. 1, the remote medical system of the present invention includes a terminal device 10 and a server 12 on a medical institution side that are connected to each other through an Internet line 11.

It is enough that the terminal device 10 is a terminal device that is at least capable of taking an electrocardiogram of a user and measuring a blood pressure thereof. For instance, there occurs no problem so long as the terminal device 10 is a terminal device obtained by using an information terminal device installed at a convenience store or the like and by adding a function of taking an electrocardiogram and measuring a blood pressure to this information terminal device.

Note that the terminal device 10 is not limited to the information terminal device described above. That is, there may be used a Chorus Net terminal or may be obtained a structure where a user directly accesses the server 12 on the medical institution side using a portable device that is capable of taking an electrocardiogram and measuring a blood pressure.

Also, there may be lent such a portable electrocardiograph/sphygmomanometer from the medical institution side. In such a case, there occurs no problem so long as the server 12 includes a database for managing the lending state of the portable device in the manner to be described later.

The server 12 includes a user database, a vital sign storing database, a counseling doctor database, and an examination result storing database. In addition, the server 12 is constructed so as to display a personal information screen, an overall check screen, an electrocardiograph/sphygmomanometer lending state check screen, a data reception screen, a data diagnosis screen, and an examinee check screen on an unillustrated monitor.

When the personal information input screen is displayed on the monitor, it is possible to input the name, telephone number, date of birth, membership number, and the like of a user (hereinafter also referred to as the “examinee” as necessary). When the overall check screen is displayed on the monitor, it is possible to confirm the overall state such as a medical examination state.

Also, when the electrocardiograph/sphygmomanometer lending state check screen is displayed on the monitor, it is possible to check the lending state of the electrocardiograph/sphygmomanometer described above. When the data reception screen is displayed on the monitor, it is possible to display a vital sign transmitted from the user. Further, when the examinee check screen is displayed on the monitor, it is possible to check various kinds of data, such as the name of the examinee, inputted through the personal information screen.

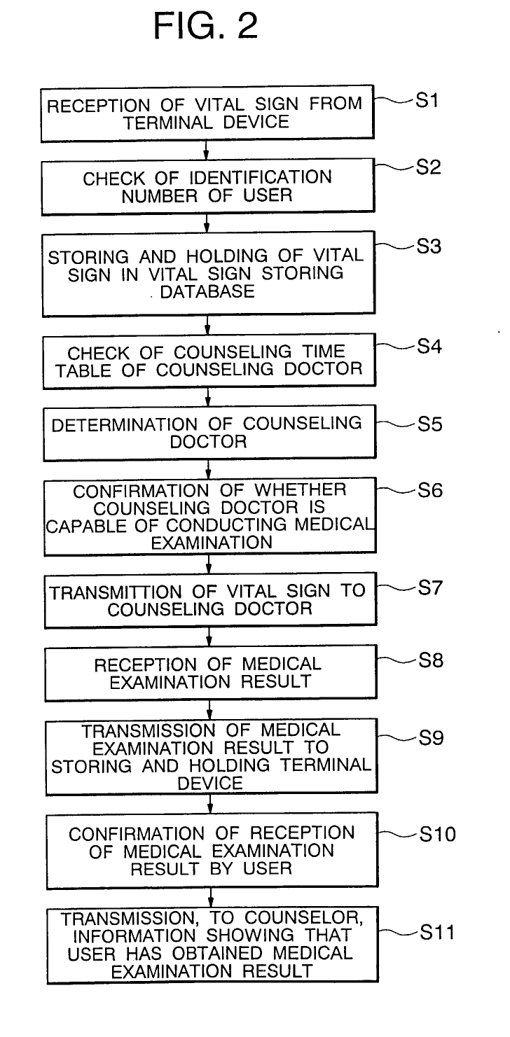

FIG. 2 is a flowchart showing the flow of medical examination using the remote medical system of the present invention.

As shown in FIG. 2, when a vital sign is received from the terminal device 10 in step S1, there is checked an identification number of the user of the terminal device 10 using the user database in step S2. After the check of the identification number, the processing proceeds to step S3 in which the vital sign is stored and held in the vital sign storing database.

Next, in step S4, in order to determine a counseling doctor who will medically examine the vital sign, there is checked a counseling time table of a plurality of counseling doctors that is stored and held in the counseling doctor database, thereby determining a counseling doctor (hereinafter referred to as the “doctor in charge”), who is currently capable of being in charge, in the following step S5.

When a counseling doctor is determined in step S5 described above, the processing proceeds to step S6 in which there is first asked the counseling doctor whether he/she is capable of performing medical examination. If an affirmative answer is returned, the vital sign is transmitted to the counseling doctor in step S7 without delay.

When a medical examination result concerning the vital sign is received from the counseling doctor in step S8, the medical examination result is stored and held in the medical examination result storing database in step S9. In addition, the medical examination result is transmitted to the terminal device 10 through the Internet line 11.

This structure allows the user to obtain the medical examination result through the terminal device 10. The presentation of the medical examination result to the user is not limited to the display on the monitor, but it is also possible to print the medical examination result. Further, the inspection result may be sent by mail.

Also, even in the case where it is impossible to obtain a medical examination result without delay in the manner described above due to a reason concerning the contents of the medical examination, circumstances of the counseling doctor, or the like, there occurs no problem by obtaining a structure where a date and time, at which it becomes possible to obtain the medical examination result, is displayed on the terminal device 10 side after there is determined a counseling doctor, who is capable of being in charge, in step S5. It is possible for the user to obtain the medical examination result at any time after the designated date and time.

Further, when it is confirmed that the user has obtained the medical examination result in step S10, the processing proceeds to step S11 in which there is transmitted, to a counselor, information showing that the user has obtained the medical examination result and there is placed a call from the counselor to the user in order to give advice on the health, nutrition, exercise, and the like.

As described above, with the remote medical system of the present invention, it becomes possible to have a counseling doctor, who is capable of being in charge, perform medical examination without delay when a vital sign is transmitted from the user to the server 12 on the medical institution side, and to instantly transmit a medical examination result to the terminal device 10 installed at a convenience store or the like. As a result, it becomes possible to provide a remote medical system that is capable of always and instantly coping with a counselee or examinee while reducing a load placed on a counseling doctor.

The remote medical system according to the present invention includes: a terminal device that measures a vital sign of a user, transmits the vital sign to a server, and receives medical information based on the vital sign from the server; and the server that transmits, to a doctor in charge, the vital sign of the user received from the terminal device and returns a medical examination result received from the doctor in charge to the terminal device. With this structure, it becomes possible to provide a remote medical system that is capable of always and instantly coping with a counselee or examinee while reducing a load placed on a counseling doctor. Also, the terminal device is an information terminal device installed at a store. As a result, it becomes possible to provide a remote medical system of high use value using a simple structure. Further, the server stores and holds a counseling time table of a plurality of counseling doctors; transmits the vital sign of the user to a counseling doctor, who is capable of being in charge, in accordance with the counseling time table in the case where a doctor in charge, who previously handled the client, is not currently on the job; and returns a medical examination result received from the counseling doctor to the user. As a result, it becomes possible to provide a remote medical system that allows the user to obtain the medical examination result without delay and provides the user with an extremely high degree of reliability.

What is claimed is:

1. A remote medical system comprising a terminal device and a server,
wherein the terminal device measures a vital sign of a user; transmits the vital sign to a server; and receives medical information based on the vital sign from the server; and
wherein the server transmits, to a doctor in charge, the vital sign of the user received from the terminal device, and returns a medical examination result received from the doctor in charge to the terminal device.

2. A remote medical system according to claim 1,
wherein the terminal device is an information terminal device installed at a store.

3. A remote medical system according to claim 1,
wherein the server stores and holds a counseling time table of a plurality of counseling doctors; transmits the vital sign of the user to a counseling doctor, who is capable of being in charge, in accordance with the counseling time table; and returns a medical examination result received from the counseling doctor to the user.
